(19) United States
(12) Patent Application Publication
(10) Pub. No.: US 2008/0216333 A1
(43) Pub. Date: Sep. 11, 2008

(54) Fastmark Groutline ruler

(76) Inventor: Carl Timothy Hoff, Corona, CA (US)

Correspondence Address: CARL TIMOTHY HOFF, 1330 ELDERWOOD DR., CORONA, CA, 92882, US

(21) Appl. No.: 11/713,879

(22) Filed: Mar. 5, 2007

(51) Int. Cl. B43L 7/08

(52) U.S. Cl. 33/494; 33/770

(57) ABSTRACT

Fastmark Groutline Ruler enables tile, stone and masonry installers to properly measure tile, stone or masonry materials which will be cut and installed between the end point and the previously installed materials on the floor or wall. This device is a two piece measuring device which will automatically deduct the size of the required grout-line(S) measurement from the fill cut, Fastmark Groutline Ruler has subtractive grout line stop block that automatically aligns to the edge of tile stone or masonry edges, even on crooked horizontal or vertical edges, removable subtractive grout line stop blocks can be mounted to standard hand held tape measure, stop blocks have a depth adapted to the depth of grout spacers installed in field area for perfect grout spacing, and subtractive grout line stop blocks that automatically subtracts for of grout line(S) sizes. Subtractive grout line stop blocks made to all grout line sizes and multiples of.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of tile, stone and masonry installations and more specifically to Fastmark Groutline Ruler.

A big problem facing installers of tile, stone or masonry products is the ability to accurately measure fill pieces at the last row of an area were said materials are installed next to a wall or end point. In the past an installer would have to measure the fill area and than try to subtract from from the measurement the grout line(S), if the subtraction was wrong or off a little it would waste a fill piece and would have to be re-cut wasting time and money. Aligning a measurement device on a edge or crooked edge or wavy edge was a guess at best, slowing down the installation process. Multiple measurement scales; slides; on the same measurement device lead to confusion. Also taking in account for the grout spacer depth has never been addressed before especially if the said material has a crooked vertical edge that tapers outward from its top to its bottom were the grout spacer rest against. Past measurement devices had a limited length and could not address the new super large sizes of tile, stone or masonry materials today. Tile, stone or masonry measurement devices never addressed being able to align the device to help make 90 degree angle cut marks along the top side of said materials especially with crooked edges to help mark cut pieces to be used as border or wall base pieces and be accurate from on end to another. Hand held tape measures could not automatically subtract grout lines from the measurement of fill cuts before.
In prior art one could use a double scale ruler to measure the fill cut by using one end to measure the fill area and than would have to measure the fill piece with the scale on the other end of the ruler to subtract the one grout line.
When using prior technology to measure the fill cut it could lead to confusion if you picked the wrong end of the double scale ruler by accident and cut the fill piece the wrong size again wasting time and money. Aligning the ruler on a jagged vertical or horizontal edge is guess work at best and leads to inaccurate cuts of the fill piece and grout line sizes. Past art only had two functions; measuring and subtracting three grout line sizes, limiting it's use. Prior technology had two measurement scales limiting it's usable size. Prior technology could not be adapted to hand held tape measures to extend it's use. Prior art did not take into account the sloping edges of some fill material edges in which grout spacers in the field area rest against to gage the grout spacing leads to inaccurate grout line size. Prior technology had three set grout sizes on ruler to be subtracted, there was no way of changing the sizes to meet the growing selection of grout spacer sizes and multiples of today. Prior art never addressed being able to align the device to help make 90 degree angle cut marks along the top side of said materials especially with crooked edges to help mark cut pieces to be used as border or wall base pieces and be accurate from on end to the other end of a cut mark. In prior technology hand held tape measures could not subtract grout lines from the measurement of fill cuts. Prior art had hard to use movable sliders that can become lose and lead to inaccurate fill cuts, again wasting time and material.

### BRIEF SUMMARY OF THE INVENTION

The primary object of the invention is To benefit the tile, stone or masonry installer to cut accurate fill pieces for the installation of such materials with automatic alignment of ruler end with a grout line subtracting stop block action.

Another object of the invention is to automatically calculate and subtract the grout lines on each side of a fill cut one or multiple grout lines.

Another object of the invention is to aid in aligning the ruler to the edge of fill piece.

A further object of the invention is to align grout line subtracting stop block end on fill piece edge to adapt to the same spacing depth as a common grout space in the field area; even with jagged vertical or horizontal edges.

Yet another object of the invention is to help draw right angle lines on fill piece top plane by placing grout line subtracting stop block on fill piece edge and using the elongated side of the ruler to draw right angle lines.

Still yet another object of the invention is to provide an accurate measuring device for other measurement needs using one measurement scale.

Another object of the invention is to draw lines between multiple measurement marks on fill piece top plane.

Another object of the invention is to have removable or fixed grout line subtracting stop blocks on end of tile, stone or masonry ruler.

A further object of the invention is to have removable grout line subtracting stop blocks of infinite sizes for various grout line sizes and multiples of.

Yet another object of the invention is to have grout line subtracting stop blocks that will attach to the end of a standard hand held tape measure and provide the same benefits as describe before.

Still yet another object of the invention is to have a unique v shape measurement scale for easy reading of measurement marks.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Fastmark Groutline Ruler comprising the steps of: a way to automatically subtract one or multiple grout lines from a fill cut, having a removable or fixed grout line subtracting stop block to automatically align edge of ruler to fill piece edge, to easily see measurements on the unique v shaped measurement scale on ruler plane, a grout line subtracting stop block to align ruler end to jagged or crooked horizontal or vertical edges of fill piece, removable or fixed grout line subtracting stop blocks of infinite sizes for all grout line sizes and multiples of, one measurement scale for easy marking of fill piece, what you measure is what you mark ease on a single measurement scale, made of a durable material for long lasting use, built-in right angle guide, can be used as a standard measurement device, removable grout line subtracting stop blocks can be mounted to standard hand held tape measure tape end, grout line subtracting stop blocks made of a depth adapted to the depth of grout spacers installed in field area to help maintain perfect grout spacing, and grout line subtracting stop blocks that automatically calculate subtractive measurements of grout sizes.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the Fastmark Groutline ruler

FIG. 2 is another perspective view of the Fastmark Groutline ruler

FIG. 3 is a plan view of the Fastmark Groutline ruler top plane

FIG. 4 is a plan view of the Fastmark Groutline ruler

FIG. 5 is a cross sectional view of the Fastmark Groutline ruler

FIG. 6 is a plan view section of the Fastmark Groutline ruler

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

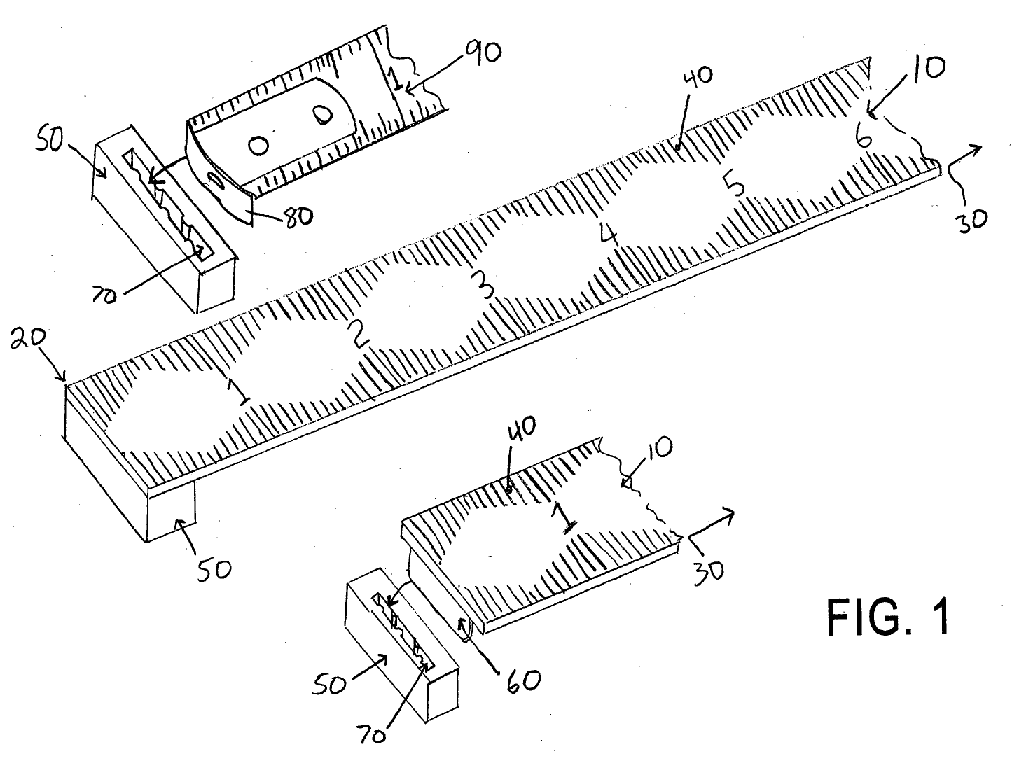

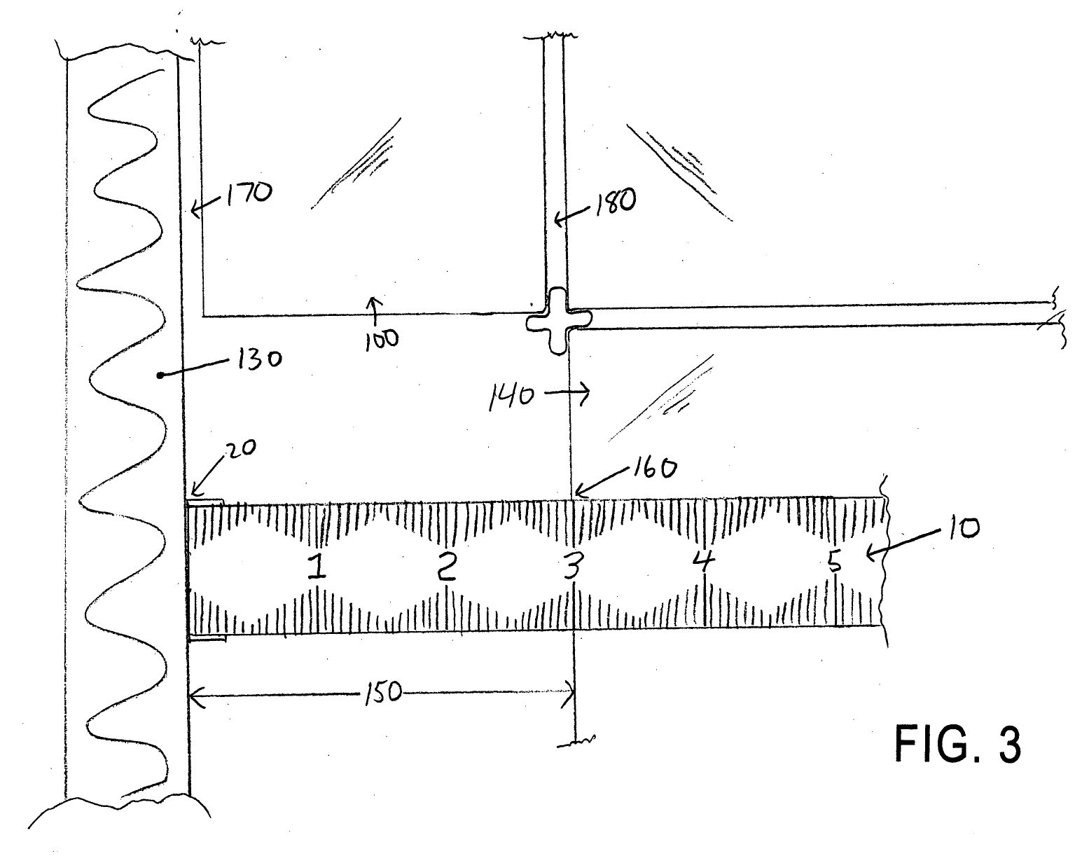

FIG. 1 is a perspective view of the Fastmark Groutline ruler (10) is the elongated face view of the Fastmark Groutline Ruler, which the ruler has a first start end (20) and second end (30) of infinite lengths and a unique V shape measurement scale (40) on it's top plane, (with a scale of standard inch or metric measurements and fractions of), comprising of a grout line subtracting stop block (50) that can be mounted on a tab (60) under the top plane (10) of the start end (20) of the Fastmark Groutline ruler (10) to hold or facilitate easy exchange of different size grout line subtracting stop blocks (50), with A slot or scarf (70) in the grout line subtracting stop block (50) made to a depth and width to also allow the tab end (80) of a standard hand held tape measure (90) to attach in the grout line subtracting stop block (50) slot (70). The grout line subtracting stop block (50) can be made to an infinite sizes to subtract one or multiples of grout line measurements to automatically subtract grout lines from fill measurement example (150) in FIG. 3 The grout line subtracting stop block (50) can also be permanently fastened to the underneath of the start end (20) of the Fastmark Groutline ruler for a set grout line size to be subtracted.

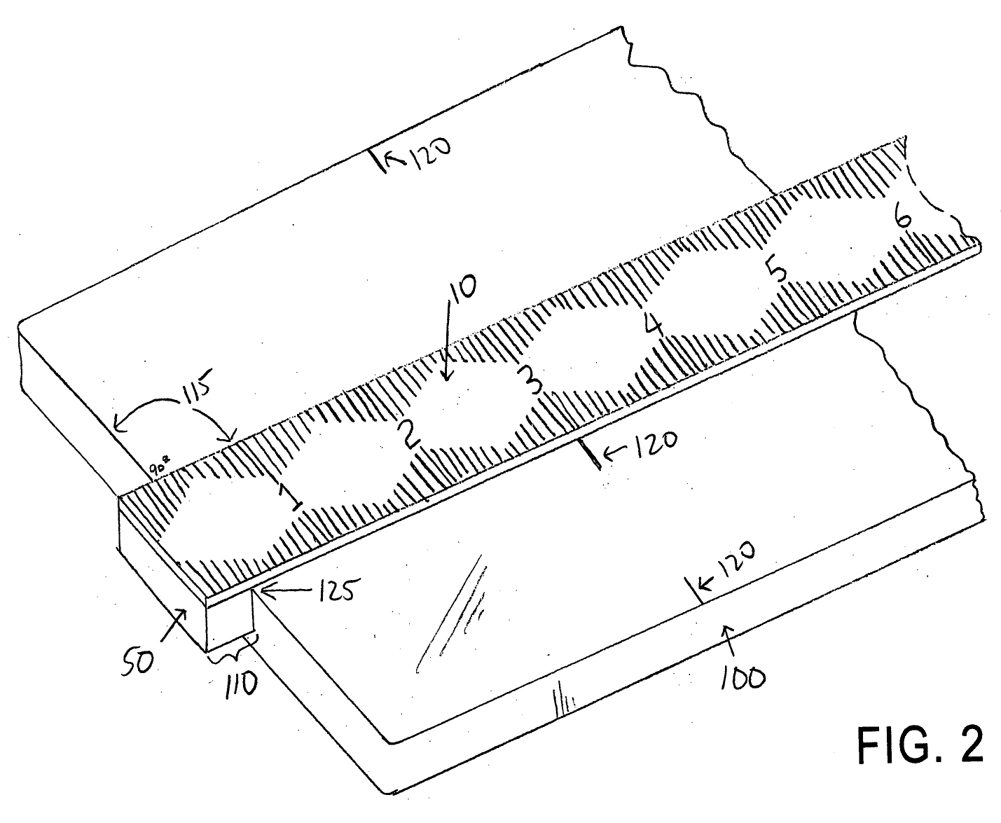

FIG. 2 is a perspective view of the Fastmark Groutline ruler (10) with a tile plate example (100) under the Fastmark Groutline ruler top plane (10) and the grout line subtracting stop block (50) resting against the tile plate example (100) edge, showing how the grout line subtracting stop block (50) subtracts the predetermined grout line amount (110) to be subtracted from the fill measurement determined earlier (example 3″ (120)) from FIG. 3 fill area (150). (125) shows how the grout line subtracting stop block (50) automatically aligns the Fastmark Groutline ruler to the edge of the tile plate example (100) for the quickest alignment time. This prevents confusion of which end of the ruler to use. A built-in 90 degree angle forms (115) when the Fastmark Groutline ruler (10) and the grout line subtracting stop block (50) are automatically aligned on the edge of tile plate example (100) to help in drawing straight 90 degree angle lines across the tile plate example (100) surface to get even bars of tile strips for tile, stone or masonry coving or trim applications when lines are drawn and said material is cut.

FIG. 3 is a plan view of the Fastmark Groutline ruler top plane (10), start end (20) is placed against a wall or end point (130) and lays on top of closest previously installed field tile, stone or masonry (140) to determine a measurement for the fill area (150) example is 3″ (160) to be used when measuring the fill piece needed in the fill area (150). The fill measurement marks (120) on FIG. 2 can now guide an installer to follow the marks when cutting the fill piece example (100), after fill cut is done, the installer can now use this fill piece example (100) to fill the area in FIG. 3 fill area (150), in this case with two grout widths subtracted (one on the wall side (170) of the fill piece example (100) and the other next to the field side (180) of the fill piece example (100)).

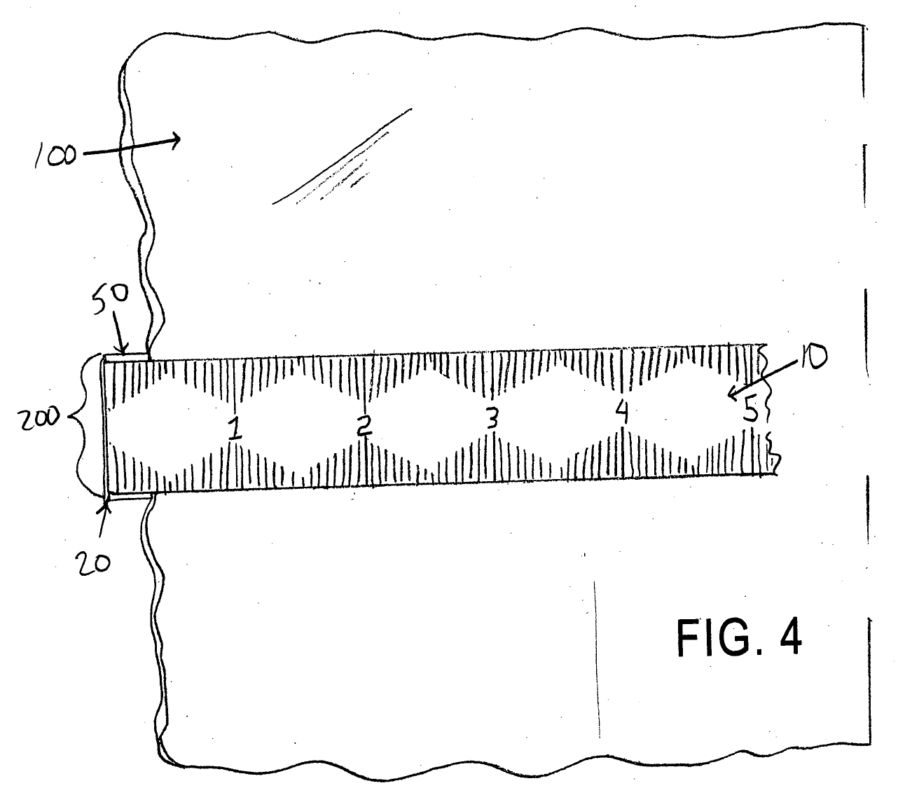

FIG. 4 is a plan view of the Fastmark Groutline ruler (10). The grout line subtracting stop block (50) on and under the start end (20) of the Fastmark Groutline ruler (10) is of a width (200) to help automatically align the Fastmark Groutline ruler on the edge of the tile plate example (100) edge even if the tile plate example (100) edge is jagged or uneven both vertically or horizontally. The width (200) of the stop block (50) can be made of infinite widths.

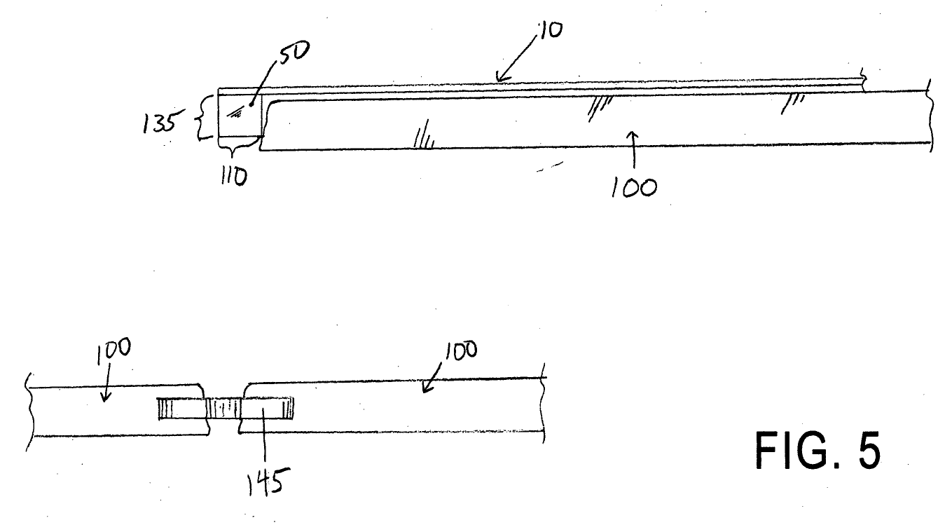

FIG. 5 is a cross sectional view of the Fastmark Groutline ruler (10). The grout line subtracting stop block (50) rest against the crooked edge of tile plate example (100) and aligns itself like a grout spacer would on the edge of the tile plate example (100) to give an accurate measurement to mark your fill cut. The width (110) of the grout line subtracting stop block (50) is of any infinite widths to account for the size of the grout line(S) to subtract when you measure for marking your tile plate example (100) fill cut. The height (135) of the grout line subtracting stop block (50) is set to the same height of grout spacers (145) used in installing tile, stone or masonry, this way the measurement mimics the same grout line the spacer makes in the field area, it accounts for the uneven edges encountered by some tile, stone or masonry edges.

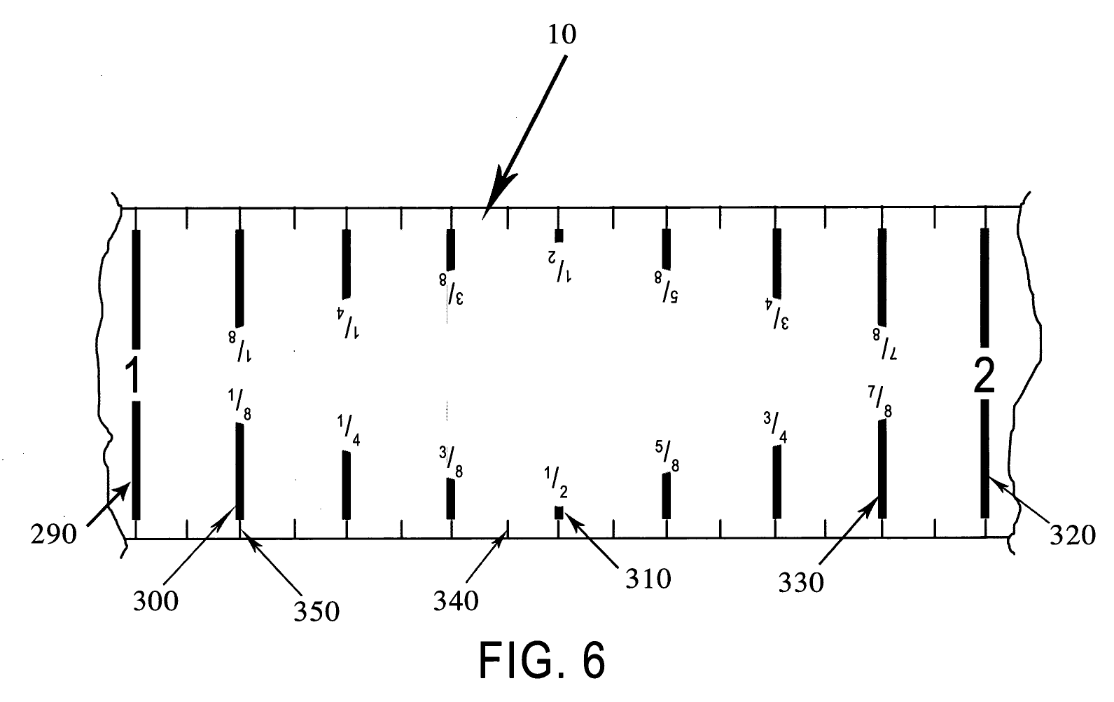

FIG. 6 is a plan view section of the Fastmark Groutline ruler (10). This unique v shaped measurement scale has a measurement mark that starts at (300) next to a whole mark example (290), scale declines down to a center point (310) between two whole mark examples (290) (320) and than scale inclines up to mark (330) next to the next whole mark example (320). Each fractional mark (300) is of a bolder width that the edge mark (340) to help visually separate measurement marks for faster reading. This unique v shaped measurement scale is repeated down the Fastmark Groutline ruler (10) between the start end and all whole measurement marks example (290) and repeated on the opposite side of the elongated face of the Fastmark Groutline ruler (10) in the same manner. The unique v shaped measurement scale can be in standard or metric increments. The unique v shaped measurement scale will have half division marks (340) between all fractional marks (300) and be of the same length, this will help in not confusing fractional marks (300) with division marks (340). The measurement mark (350) between fractional mark (300) and the edge of the Fastmark Groutline ruler (10) is of a size to facilitate accurate measurements of the fractional mark (300)

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Fastmark Groutline Ruler comprising the steps of:
a way to automatically subtract one or multiple grout lines from a fill cut;
having a removable or fixed grout line subtracting stop block to automatically align edge of ruler to fill piece edge; to easily see measurements on the unique v shaped measurement scale on ruler plane; a grout line subtracting stop block to align ruler end to jagged or crooked horizontal or vertical edges of fill piece;
removable or fixed grout line subtracting stop blocks of infinite sizes for all grout line sizes and multiples of;
one measurement scale for easy marking of fill piece;
what you measure is what you mark ease on a single measurement scale;
made of a durable material for long lasting use;
built-in right angle guide;
can be used as a standard measurement device.

2. Fastmark Groutline Ruler comprising the step of: a removable grout line subtracting stop block that can be mounted to standard hand held tape measure tape end and subtract Groutline(s) from measurement automatically; what you measure is what you mark measurements.

3. Fastmark Groutline Ruler comprising the steps of: a grout line subtracting stop block made of a depth adapted to the depth of grout spacers installed in field area to help maintain perfect grout spacing; and grout line subtracting stop blocks that automatically calculate subtractive measurements of grout sizes.
